(19) United States
(12) Patent Application Publication
(10) Pub. No.: US 2015/0300782 A1
(43) Pub. Date: Oct. 22, 2015

(54) CARBON NANOTUBE-REINFORCED FABRIC, ASSEMBLY AND RELATED METHODS OF MANUFACTURE

(71) Applicants: Richard Gene Craig, Holladay, UT (US); Agnes E. Ostafin, Layton, UT (US)

(72) Inventors: Richard Gene Craig, Holladay, UT (US); Agnes E. Ostafin, Layton, UT (US)

(21) Appl. No.: 13/829,660

(22) Filed: Mar. 14, 2013

(51) Int. Cl. F41H 5/02; B32B 37/10; B32B 27/12; F41H 5/04; B32B 5/26

(52) U.S. Cl. CPC F41H 5/023; F41H 5/0485; F41H 5/0478; B32B 5/26; B32B 27/12; B32B 37/10; B32B 2571/02; B32B 2255/20; B32B 2264/108; B32B 2307/718

(57) ABSTRACT

The present invention provides fabrics that have been embedded with nano- and micro-particles in a tunable gradient. This gradient, in turn, confers a gradient of mechanical and permeation properties. The gradient configuration results in a fabric that possesses increased flexibility and reduced weight relative to its protective properties as compared to untreated fabric and other commercially available fabrics. The treated fabric may be used to produce a composite that comprises one or more layers of treated fabric bonded to either side of a sheet of elastomeric material. Such composites may be used to produce protective body armor. Methods of manufacturing the treated fabric are also provided.

### BACKGROUND OF THE INVENTION

Anti-projectile/anti-stab fabrics for body armor are typically constructed from polyaramid materials or, more recently, fibrous materials such as ultrahigh weight polyethylene, basalt, and others. However, these fabrics are relatively inflexible and heavy weight creating discomfort and reduced mobility when worn as a protective garment. Certain embodiments disclosed herein address the problem by embedding carbon nano- or micro-particles in a tunable gradient of mechanical and permeation properties within the fibers of the fabric. This configuration improves the anti-projectile/anti-stab capabilities of the fabric while preserving flexibility and maintaining a manageable weight.

### BRIEF DESCRIPTION OF THE DRAWINGS

The written disclosure herein describes illustrative embodiments of the anti-projectile/anti-stab fabric that are non-limiting and non-exhaustive. Reference is made to certain of such illustrative embodiments that are depicted in the figures, in which:

FIG. 1 illustrates a cross sectional view of a fabric of woven fibers with interstitial carbon nanotubes embedded in a gradient of decreasing density from the exterior-facing surface to the interior-facing surface of the fabric.

FIG. 2 illustrates a fabric of woven fibers, similar to that shown in FIG. 2, with the carbon nanotubes embedded in a density gradient that decreases from the exterior-facing surface toward the center of the thickness of the fabric and from the interior-facing surface toward the center of the thickness of the fabric. In this embodiment, the fabric has been treated on both sides to embed the carbon nanotubes into the fabric.

FIG. 3 is a perspective view of a fabric in which the density gradient of carbon nanotubes is configured to decrease horizontally across the length of a section of fabric.

FIG. 4 is a front perspective view of a preferred embodiment of the article of this invention. It represents a protective vest fabricated from the anti-projectile/anti-stab fabric disclosed herein.

FIG. 5a illustrates an embodiment in which multiple layers of carbon nanotube-embedded fabric are bonded to either side of a sheet of an elastomeric material.

FIG. 5b is a cross sectional view of the embodiment illustrated in FIG. 5a.

FIG. 6 is a diagram that illustrates an apparatus for use in a large-scale method of manufacturing fabric as disclosed herein.

### INDEX OF ELEMENTS IDENTIFIED IN THE DRAWINGS

| | Description of Part |
|---|---|
| 100 | fabric treated on one side |
| 110 | cross section of fiber of fabric 100 |
| 120 | fiber of fabric 100 running horizontally |
| 130 | CNT between fibers |
| 140 | CNT within fibers of fabric 200 |
| 200 | fabric treated on two sides |
| 210 | cross section of fiber of fabric 200 |
| 220 | fiber of fabric 200 running horizontally |
| 230a | CNTs embedded from exterior-facing surface of fabric |
| | 200 |
| 230b | CNTs embedded from interior-facing surface of fabric |
| | 200 |
| 240 | CNT within fibers of fabric 200 |
| 250 | exterior-facing surface |
| 260 | interior-facing surface |
| 300 | fabric with longitudinal gradient of CNTs |
| 330 | CNTs |
| 400 | anti-projectile/anti-stab vest |
| 410a, b, c | maximal flexibility fabric |
| 420a, b, c | maximal anti-permeation fabric |
| 500 | composite comprising multiple layers of fabric bonded |
| | to a sheet of elastomeric material |
| 510a-g | layers of CNT-embedded fabric |
| 520 | sheet of elastomeric material |
| 530 | exterior-facing surface of the elastomeric material |
| 540 | interior-facing surface of the elastomeric material |
| 550 | exterior-facing surface of the composite |
| 560 | interior-facing surface of the composite |
| 600 | conveyor-belt system for large-scale treatment of fabric |
| 610 | untreated fabric |
| 620a-b | spindles |
| 630 | application station |
| 640 | drying station |
| 650a, b | arrows depicting direction of spindle rotation |
| 660 | treated fabric |
| 665 | untreated reverse side of fabric |
| 670a, b | sprayers in application station |
| 680a, b | rolling applicators in application station |
| 690a, b | radiant heaters |
| 695 | hair-like applicators |

### DETAILED SUMMARY

Detailed embodiments of the present invention are disclosed herein. However, it is to be understood that the disclosed embodiments are merely exemplary of the invention, which may be embodied in various forms.

The present invention relates to anti-projectile/anti-stab fabrics that may be used to construct body armor and methods of producing such fabrics. In particular, the invention relates to fabrics which are embedded with carbon nano- or micro-particles in a tunable density gradient. The density of nano- or micro-particles directly correlates with the mechanical and permeation properties within the fibers of the fabric and inversely correlates with the flexibility of the fabric. Different embodiments of the fabric may be produced that have different mechanical, permeation, and flexibility properties.

The fabric may be constructed of at least one of fibers, yarns or tow. Examples of fibers include, but are not limited to, nylon, polyaramid, polyester, polyurethane, polynitriles, polyethylene, polypropylene, polyvinylchloride, polystyrene, polyacrylonitrile, polytetrafluoroethylene, polymethyl methacrylate, polyvinyl acetate, or natural fibers. Preferably, the fabric is constructed of polyaramid, known as Kevlar, which is commonly used to produce anti-ballistic body armor.

The fabric is embedded with nano- or micro-particles, including, but not limited to, carbon nanostructures, preferably carbon nanotubes (CNTs). The CNTs may be single-walled or multi-walled. In a preferred embodiment, the fabric is embedded with multi-walled CNTs. The particles are embedded in the interstitial spaces between the fibers of the fabric in the configuration of a density gradient, the greater density being near the surface of the fabric wherein the density decreases across the thickness of the fabric.

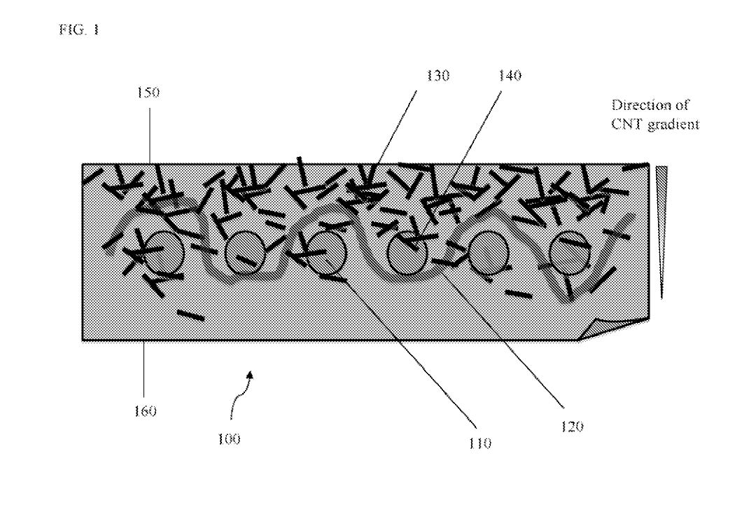

FIG. 1 is a cross sectional view of an embodiment of a fabric 100 with CNTs configured in a density gradient with the density decreasing from the surface of the fabric across the thickness of the fabric. The fabric 100 comprises an exterior-facing surface 150 that was treated using the process of the disclosure through which CNTs 130 are embedded and an interior-facing surface 160 that was not treated as disclosed herein. Cross sections of fibers 110 are illustrated with CNTs 130 positioned in the interstitial space between them. A horizontal running fiber 120 is depicted as a fiber that is woven between the fibers shown as cross sections of fibers 110. In the embodiment shown in FIG. 1, the gradient is depicted as an even and gradual change in density of the CNTs 130. However, in other embodiments, the change in density is uneven, such as in a stair-step configuration that may or may not be configured to have equal increments of change. In fact, depending on the mechanical, permeation, and flexibility requirements of the treated fabric, the rate of decrease in density may be quite inconsistent across the thickness of the fabric 100. The density gradient in FIG. 1 is simply meant to depict the characteristic of this embodiment wherein the amount of carbon nanostructures on exterior-facing surface 150 is greater than the amount of carbon nanostructures on the interior-facing surface 160.

In addition to a gradient of nano- or micro-particles that spans from the surface of the fabric across the thickness of the fabric, there may be a gradient across the thickness of individual fibers. FIG. 1 depicts CNTs 140 that are embedded within the individual fibers. The density of such a gradient decreases from the exterior to the interior of the fibers.

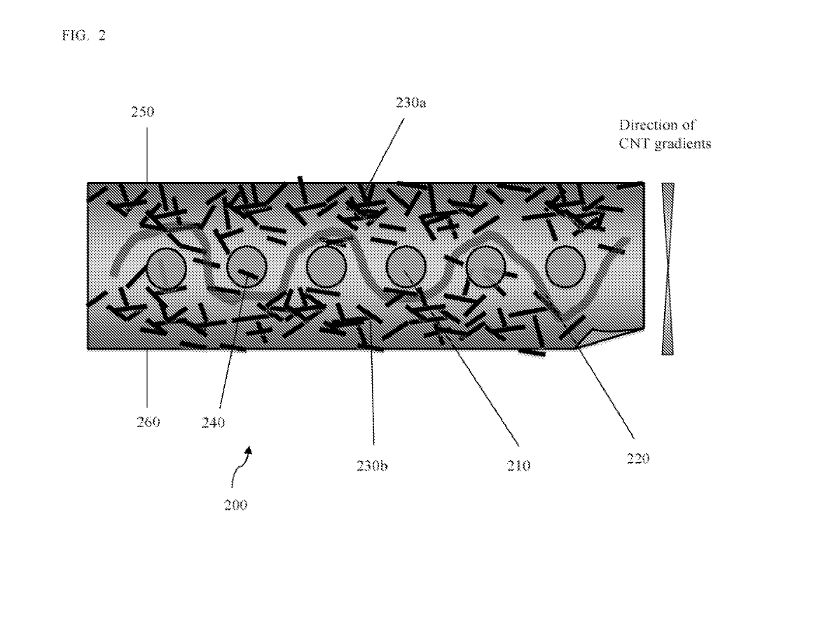

In another embodiment illustrated in FIG. 2, fabric 200 has been treated according to the disclosure on both an exterior-facing surface 250 and an interior-facing surface 260. Similar to FIG. 1, FIG. 2 illustrates a cross sectional view of an embodiment of a fabric 200 with CNTs 230a configured in a density gradient with the density decreasing from the exterior-facing surface 250 of the fabric 200 across the thickness of the fabric 200 and with CNTs 230b configured in a density gradient with the density decreasing from the interior-facing surface 260 of the fabric 200 across the thickness of the fabric 200. Similar to the embodiment illustrated in FIG. 1, the CNTs 230a and 230b are embedded in the interstitial space between the fibers. Also as in FIG. 1, a horizontal running fiber 220 is shown which is woven between the fibers which are shown as cross sections of fibers 210. More specifically, CNTs 230a and 230b are shown between fibers 220 and 210. As disclosed with regard to the embodiment depicted in FIG. 1, the gradient in FIG. 2 is illustrated as an even and gradual change in density of the CNTs 230a and 230b from the exterior facing surface 250 and from the interior-facing surface 260 respectively. However, the rate of decrease in density may be quite inconsistent across the thickness of the fabric 200 as described with regard to the embodiment illustrated by FIG. 1. The rate of decrease in density of CNTs 230a or 230b may be inconsistent on one or both surfaces of the fabric 200. As with the embodiment illustrated in FIG. 1, CNTs 240 are embedded within the individual fibers. The density of such a gradient decreases from the exterior to the interior of the fibers in a manner similar to that described with regard to the embodiment of FIG. 1.

One advantage provided by fabrics disclosed herein is that the gradient configuration confers strength against breaking to the fabric as well as different mechanics of breaking. This, in turn, provides enhanced anti-projectile/anti-stab capabilities to the fabric. More specifically, the direction of the projectile is controlled by the design of the CNT gradients. For example, the configuration of the gradient could cause the fabric to preferentially bend in a specific direction. In one example, when a projectile makes contact with a fabric that is configured, through its CNT gradient, to preferentially bend inward without breaking, the energy of the projectile would be dissipated. Certain embodiments of the invention configure the CNT gradient such that the direction of the projectile is altered. For example, a bullet which contacts the exterior surface of the fabric while moving in a direction that is perpendicular to the fabric may be redirected laterally and in a direction that is no longer directly toward the wearer of the body armor. In doing so, the bullet loses energy. By choosing the desired embodiment according to the present disclosure, the desired level of protection relative to the threat may be achieved while still maintaining a lighter weight and greater flexibility than commercially available fabrics that offer a similar of protection.

In some embodiments disclosed herein, the advantages of the CNT gradient may be enhanced by layering the fabrics. In one embodiment, the directions in which the layers of fabric preferentially bend are alternated. This configuration creates chambers between opposing sheets as the projectile passes through the layers of fabric. The chambers trap the projectile and thereby, reduce its velocity. By improving the anti-projectile/anti-stab capabilities of the fabric through proper configuration of the one or more CNT gradients, fewer layers of fabric are needed to achieve the desired level of protection. Consequently, the fabric is lighter and more flexible than other fabrics on the market. A user is better able to perform physical activities while wearing body armor constructed of the fabric, is more comfortable, and consequently, more likely to wear the body armor in combat or other hazardous situations. Ease of movement while wearing the body armor provides an added level of level of safety for the wearer. Furthermore, the wearer is better able to perform required activities while wearing the body armor which increases efficiency and productivity.

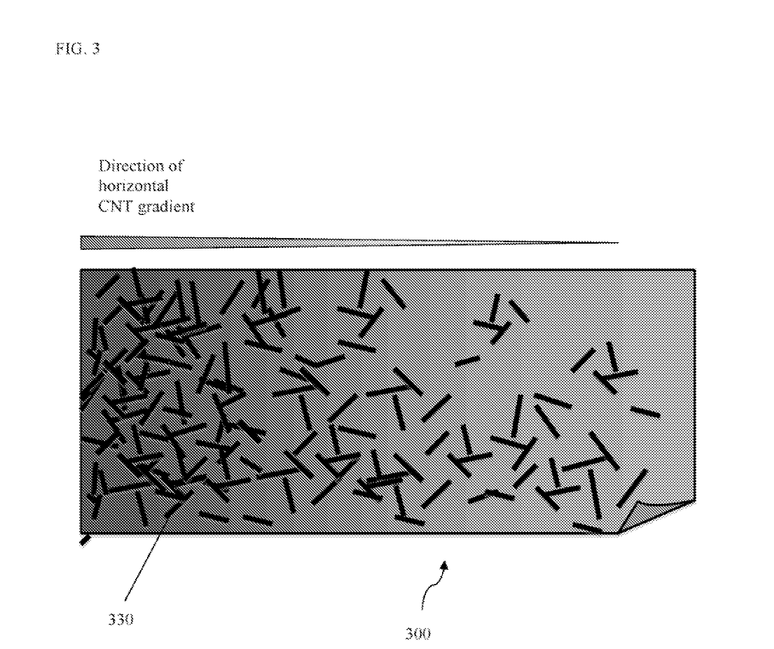

The nano- or micro-particles may also be configured in a density gradient along the length of the fabric. FIG. 3 is a perspective view of a sheet of fabric 300 which is an embodiment according to the present disclosure. In FIG. 3, the CNTs 330 are embedded in the fabric 300 in a gradient that runs horizontally along the length of the fabric 300. Similar to the gradients shown in FIGS. 1 and 2, the gradient is depicted in FIG. 3 as an even and gradual change in density of the CNTs 330. Alternatively, as discussed herein with regard to the embodiments illustrated in FIGS. 1 and 2, the rate of decrease in CNT density may be quite inconsistent across the length of the fabric. The change in density may be in a stair-step configuration. Alternatively, there may be strips of fabric along the length of the larger section of fabric that have different CNT densities. The different CNT densities may also be present in a patchwork configuration.

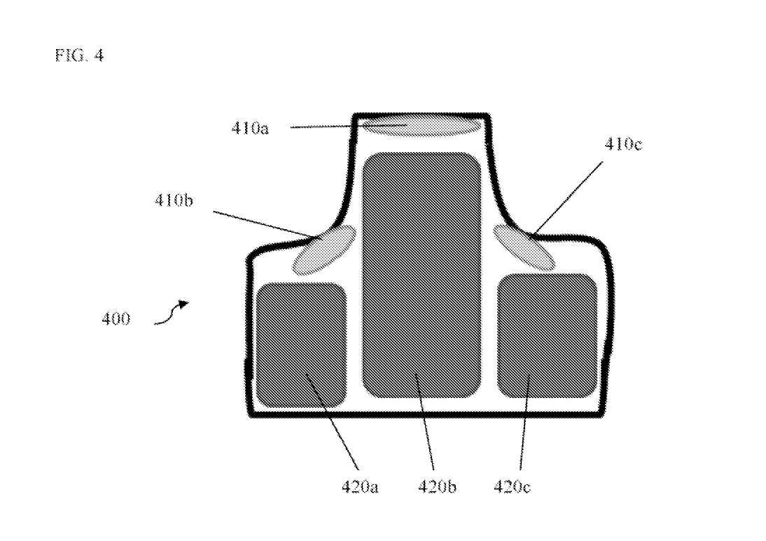

FIG. 4 is a protective vest 400 constructed of the anti-projectile/anti-stab fabric described herein. The vest is constructed from different embodiments of the fabric which may include, but are not limited to, those illustrated in FIGS. 1 and 2. Portions of the vest that cover sections of the body that do not often bend, but require maximal protection, are constructed from an embodiment of the present disclosure comprising fabric that has maximal anti-permeation properties 420a, 420b, and 420c (dark grey). Such areas include the chest, abdomen, and back. Alternatively, other portions of the vest cover sections of the body that require fabric with greater flexibility 410a-c (light grey) but for which less than maximal permeation properties are practical. Such portions of the vest include the areas under the arms, which are less exposed but which require maximum flexibility for movement of the arms 410b and 410c. Another such portion of the vest is the area around the neckline 410a which allows the wearer to comfortably move his or her head and neck. Less than maximal permeation properties in this portion of the vest are a practical in exchange for greater flexibility because a lethal projectile that impacts the wearer at the neckline, without anti-projectile protection above the neck, is unlikely to significantly impact the safety of the wearer.

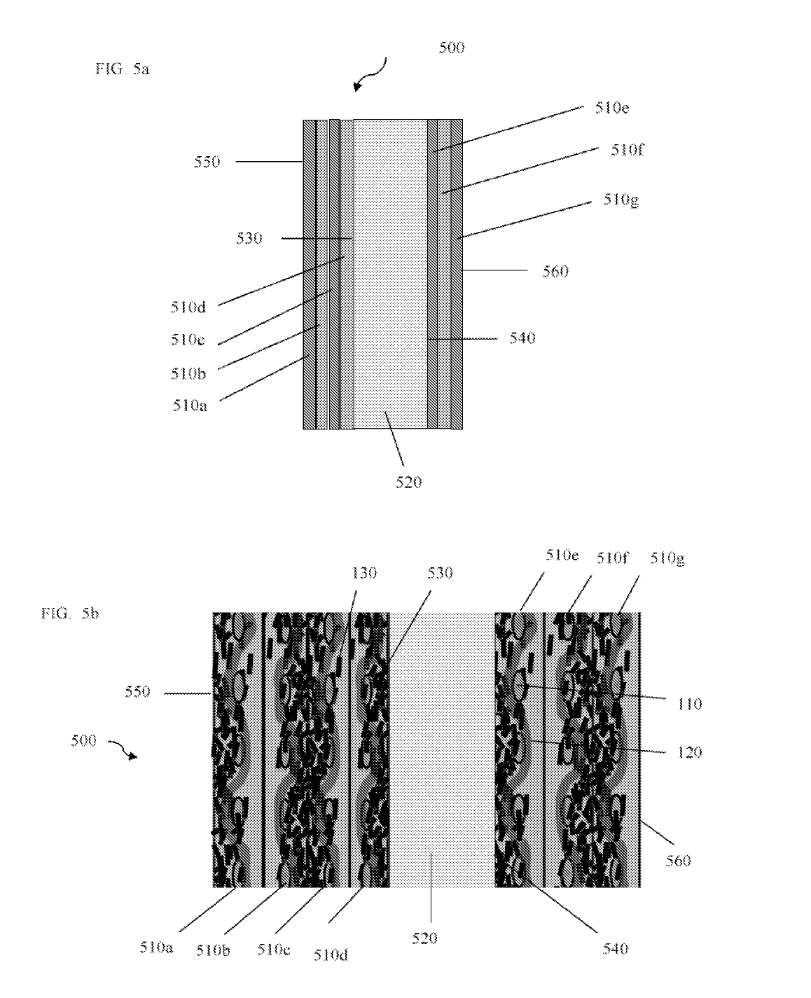

FIGS. 5a and 5b illustrate a composite 500 that represents preferred embodiment of the invention in which one or more layers of CNT-embedded fabric 510a-g are bonded to each side of a sheet of an elastomeric material 520. In this embodiment, there are four layers of CNT-embedded fabric 510a-d bonded to an exterior-facing surface 530 of the elastomeric material 520 and three layers of CNT-embedded fabric 510e-f adhered to an interior-facing surface 540 of the elastomeric material 520. The elastomeric material 520 may be comprised of one or more of polyisoprene, butadiene, chloroprene, neoprene, styrene-butadiene-blend, nitrile ethylene-propylene blend, epichlorohydrin, polyacrilic silicone, fluorosilicone, fluoroelastomers, polyether block amide, chlorosulfonated polyethylene, ethylene-vinyl acetate, polysulfide, polyacetylene, polyphynylene vinylene, polypyrrole, polythiphene, polyaniline, or polyphenylene sulfide. Preferably, the elastomeric material 520 is polyethylene.

FIGS. 5a and 5b illustrate an embodiment in which the layers of fabric have CNTs embedded from a single surface of the fabric as illustrated in FIG. 1. Fabrics 520a-g are positioned such that the surface of the fabric with the highest CNT density is alternatively facing towards or away from an exterior-facing surface 550 or interior-facing surface 560 of the composite. Specifically, fabrics 510a and 510c (dark grey) on the side of the exterior-facing surface 530 of the elastomeric material 520 are configured such that the side of the fabric with the highest CNT density is facing away from the exterior-facing surface 530 of the elastomeric material 520. Fabrics 510e and 510g (dark grey) that are bonded to the interior-facing surface 540 of the elastomeric material 520 are configured such that the highest CNT density faces towards the interior-facing surface 540 of the elastomeric material 520. Alternatively, fabrics 510b and 510d (light grey) that are bonded to the exterior-facing surface 530 of the elastomeric material 520 are configured such that the side of the fabric with the highest CNT density faces toward the exterior-facing surface 530 of the elastomeric material 520. Fabric 510f (light grey) is configured such that the side of the fabric with the highest CNT density is facing away from the interior-facing surface 540 of the elastomeric material 520.

FIG. 5b is a cross sectional view of the composite illustrated in FIG. 5a. The CNTs 130 are shown in the layers of fabric 510a-g such that the alternating positioning of the layers of fabric 510a-g on either side of the sheet of elastomeric material 520 are depicted. It is such an embodiment that creates chambers between opposing sheets as the projectile passes through the layers of fabric as described herein. Variations of the embodiment illustrated in FIGS. 5a and 5b comprise the section 410a-c and 420a-c of the vest 400 illustrated in FIG. 4.

The properties of the embodiments of the fabrics may vary with respect to certain physical parameters. The weight of the CNT-embedded fabric may be within the range of about 196 g/m² and about 772 g/m². Preferably the weight of the CNT-embedded fabric may is within the range of about 240 g/m² and about 280 g/m².

Table 1 provides physical parameters of composites and anti-ballistic vests made from the composites according to the disclosure. Each represents a different embodiment of the invention. Product number 34, highlighted in grey, meets the Ballistic Resistance of Body Armor National Institute of Justice (NIJ) Standard-0101.06. This is a set of performance standards for body armor created by the Office of Science and Technology to establish and maintain performance standards in response to a mandate of the Homeland Security Act of 2002. Backface deformation data in presented in Table 1 are the result of testing according to NIJ Body Armor Classification, Type II standards using a 9 mm weapon and reported as mm backface deformation +/−2 mm.

TABLE 1
Properties of Embodiments of Anti-Ballistic Vests

| | | Weight | | |
|---|---|---|---|---|
| Product | Backface | of fabric | Weight of | Weight of |
| Number | deformation (mm) | (g/m²) | composite (lb/ft²) | Vest (lbs.) |
| 1 | 26.50 | 3786.14 | 0.78 | 4.17 |
| 2 | 28.50 | 3421.03 | 0.70 | 3.77 |
| 3 | 30.07 | 3508.05 | 0.72 | 3.87 |
| 4 | 30.50 | 4629.34 | 0.95 | 5.10 |
| 5 | 31.33 | 3551.67 | 0.73 | 3.91 |
| 6 | 31.33 | 3424.82 | 0.70 | 3.77 |
| 7 | 31.38 | 3063.07 | 0.63 | 3.38 |
| 8 | 31.38 | 3501.56 | 0.72 | 3.86 |
| 9 | 31.67 | 3352.58 | 0.69 | 3.69 |
| 10 | 31.86 | 3212.05 | 0.66 | 3.54 |
| 11 | 32.00 | 3623.22 | 0.74 | 3.99 |
| 12 | 32.13 | 3063.07 | 0.63 | 3.38 |
| 13 | 32.50 | 3576.72 | 0.73 | 3.94 |
| 14 | 32.50 | 3335.00 | 0.68 | 3.68 |
| 15 | 33.00 | 3857.79 | 0.79 | 4.25 |
| 16 | 33.38 | 3499.09 | 0.72 | 3.86 |
| 17 | 33.38 | 3499.09 | 0.72 | 3.86 |
| 18 | 33.40 | 3508.05 | 0.72 | 3.87 |
| 19 | 33.50 | 3335.00 | 0.68 | 3.68 |
| 20 | 33.50 | 3063.07 | 0.63 | 3.38 |
| 21 | 33.75 | 3499.09 | 0.72 | 3.86 |
| 22 | 33.75 | 3436.18 | 0.70 | 3.79 |
| 23 | 33.83 | 3212.05 | 0.66 | 3.54 |
| 24 | 34.38 | 3717.25 | 0.76 | 4.10 |
| 25 | 34.50 | 3212.05 | 0.66 | 3.54 |
| 26 | 35.50 | 3352.58 | 0.69 | 3.69 |
| 27 | 36.00 | 3671.23 | 0.75 | 4.05 |
| 28 | 36.67 | 3595.78 | 0.74 | 3.96 |
| 29 | 37.00 | 3603.56 | 0.74 | 3.97 |
| 30 | 37.50 | 3780.56 | 0.77 | 4.17 |
| 31 | 39.83 | 3603.56 | 0.74 | 3.97 |
| 32 | 40.00 | 3249.56 | 0.67 | 3.58 |
| 33 | 41.67 | 3666.45 | 0.75 | 4.04 |
| 34 | 32.00 | 4201.38 | 0.86 | 4.63 |

Table 2 provides a comparison of relevant performance properties of an embodiment according to the disclosure to the properties of two commercially available anti-ballistic fabrics. The embodiment of the invention shown in Table 2 has superior strength at break then the other products. This means that the fabric will not break as easily when stretched by a projectile. This embodiment has a superior Young's Modulus, a measure of elasticity, relative to both Kevlar 129 and Dyneema. The V50 for the embodiment of the invention is superior to Kevlar which was not embedded with CNTs according to the invention and comparable to Dyneema, which is a fabric comprised of ultra-high molecular weight polyethylene. In other words, the embodiment of the invention presented in Table 2 has similar or better anti-projectile properties as compared to Kevlar 129 and Dyneema but with enhanced flexibility.

TABLE 3
Comparison of Properties of Fabrics

| | Embodiment of | | |
|---|---|---|---|
| | the Invention | KEVLAR 129 | DYNEEMA |
| Tensile Strength at Break | 19 | 3.6 | 1.4-3.1 |
| (GPa) | | | |
| Young's Modulus (GPa) | 259 | 99 | 172 |
| Elongation (%) | 7.3 | 3.3 | 4.5 |
| Areal density per sheet | 265 | 196 | 195 |
| (g/m²) | | | |
| V50 (ft/s) | 1350 | 1716 | 1300 |

With regard to Table 2, ultimate tensile strength or tensile strength at break is the maximum stress that a material can withstand while being stretched or pulled before failing or breaking. It is measured as force per unit area and the units are N/m². E=Young's modulus or elastic modulus of an object is defined as the slope of its stress-strain curve in the elastic deformation region. The units of Young's modulus are (N/m²) or (psi) or (Pa). E=stress/strain=(Force/Area)/(ΔL/L). Areal density is calculated as the mass per unit area. V50 is the velocity at which 50 percent of the shots go through and 50 percent are stopped by the armor. Structural Analysis of Polymeric Composite Materials, M. E. Tuttle, Dekker 2004 pp. 17-18. Data are for comparable weight of fabric tested.

The ultimate elongation of an engineering material is the percentage increase in length that occurs before it breaks under tension. Ultimate elongation values of several hundred percent are common for elastomers and film/packaging polyolefins. Rigid plastics, especially fiber reinforced ones, often exhibit values under 5%. The combination of high ultimate tensile strength and high elongation leads to materials of high toughness.

Table 3 compares the tensile strength and flexibility of six different samples (A-F) of an embodiment of the invention to those of Kevlar 129. Each of the six samples were found to have a greatly enhanced tensile strength and measure of elasticity as compared to Kevlar 129. An optimal amount of CNTs relative to weight of Kevlar fabric, or other fabric described herein, may be selected for specific threat levels and types. The data depicted in Tables 2 and 3 demonstrate the improvement the present invention provides to the state of the art. This is particularly evident because the tested embodiments of the disclosure comprise Kevlar fabric that was treated according to the present disclosure. The data show that the treated fabric prevents bullet penetration, reduces backface deformation by spreading the kinetic energy, dissipates the heat of the impact over a larger footprint, and has a longer work life than other ballistic protection fabrics. Furthermore, the treated fabric is light, thin and flexible and can be made in several versions tailored for specific types of threats and uses. Finally, the treated fabric is water resistant and retains full performance after conditioning.

TABLE 3
Mechanical Test Data: Comparison of Samples with Kevlar 129

| | | Samples of Invention | | | | | |
|---|---|---|---|---|---|---|---|
| SAMPLE | KEVLAR 129 | A | B | C | D | E | F |
| Tensile | 3.6 | 18 | 18 | 19 | 17 | 14 | 13 |
| Strength at | | | | | | | |
| Break (GPa) | | | | | | | |
| Young's | 99 | 245 | 234 | 259 | 183 | 177 | 152 |
| Modulus at | | | | | | | |
| Break (GPa) | | | | | | | |

The invention includes a process for treating fabrics to embed nano- or micro-structures as described herein. The process has been optimized overcome the natural difficulties encountered with high and low loading of nano- or micro-structures. In general, providing too little nano- or micro-structures in the processing can create problems in uniformity of coverage at the microscopic scale. There are simply not enough nano- or micro-structures in the mixture to provide uniform effect. Too high nano- or micro-structure content poses processing difficulties as the application materials become highly viscous. The process disclosed herein addresses this problem by the addition of diluents aimed at improving nano- or micro-structure distribution. This method represents a single embodiment of a method of treating fabric to produce an embodiment of the nano- or micro-structure embedded fabric as described herein.

According to one embodiment of the manufacturing methods disclosed herein, the fabric is first cut and blocked (meaning it is tacked down on the ends so it does not twist or distort). A solvent is spread over the fabric surface with a sponge and allowed to air dry for a maximum of 15 minutes. Examples of solvents that may be used for this process are n-methyl pyrrolidone, toluene, hexane, chloroform, acetone, methyl acetate, ethanol, methanol, demethyl formamide, dimethylsulfoxide, isopropanol, enzymes, and detergent. One or more chemicals on this list of solvents may be used in the process. Preferably, the solvent will be n-methyl pyrrolidone or toluene. The solvent causes the fibers of the fabric to swell making a larger space between the molecules of the fibers. The swelling allows the CNTs to move into the spaces between the molecules of the fiber.

After being treated with a solvent, the fabric is then impregnated with CNTs. The CNTs are mixed with an adhesive to form a viscous substance. Preferably, the adhesive is not water based. Examples of materials that may be used alone or in combination to make the adhesive are polychlorinated rubber, rosin ester, phenolic resin, toluene, or other volatile organic solvents. The nanostructure-adhesive mix is applied to the fabric with a sponge and pressed into the fabric with between 10 and 70 pounds of pressure/9 inches². A roller or squeegee may be used to press the mixture into the fabric. The method has been designed to embed the proper amount of CNTs into the fabric. The method of producing the fabric may also include the step of mechanically softening the projectile-resistant fabric by sonication, vibration, rolling, pressing, heating or pounding.

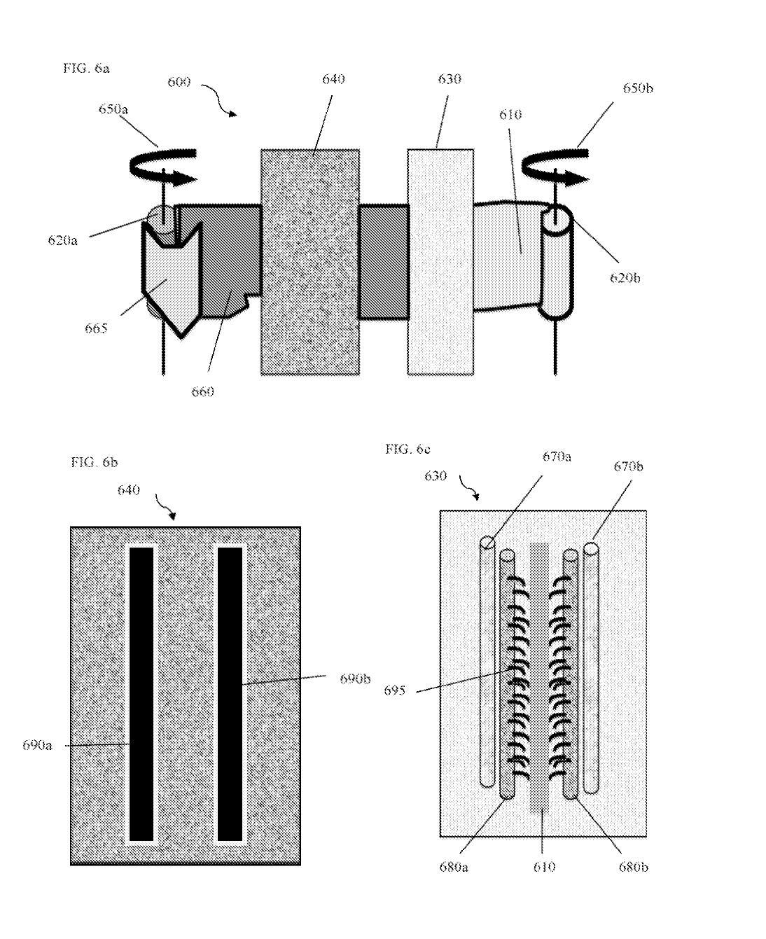

The methods of the invention are scalable. FIG. 6 discloses an embodiment of a large-scale production method. According to the embodiment of FIG. 6, the anti-projectile fabric is produced in a continuous fashion on a conveyor belt system 600 wherein the nanotube gradient is produced first on one side of the fabric then on the other.

First, solvent is applied to the long strip of untreated fabric 610 and the fabric allowed to dry as described with regard to the small-scale production method. The untreated fabric 610 will then be tacked onto a conveyer belt and wrapped around spindles 620a and 620b to secure the untreated fabric 610. Arrows 650a and 650b illustrate the rotational direction of the spindles. The conveyor belt system 600 moves the untreated fabric 610 underneath an application station 630 that sprays CNT/adhesive mixture onto the untreated fabric 610.

FIG. 6c provides a more detailed illustration of the application station 630. The application station 630 comprises two sprayers 670a and 670b that spray CNT-adhesive mixture onto the untreated fabric 610. The CNT/adhesive mixture is then spread and mechanically pressed into the fabric with roller applicators 680a and 680b. The roller applicators 680a and 680b have flexible hair-like structures 695 that spread the CNT/adhesive mixture over the surface of the untreated fabric 610.

After passing through the application station 630, the treated fabric 660 moves along the conveyor belt system 600 to the drying station 640. FIG. 6b provides a more detailed illustration of the drying station 640. The drying station 640 comprises radiant heaters 690a and 690b which dry the treated fabric 660. The treated fabric 660 may then be removed from the conveyor belt system 600. Optionally, the treated fabric 660, which is treated on one surface only, may be flipped over and treated on the opposite side according to an embodiment of the method described herein. The embodiment of the method used to treat one side of a given fabric may be essentially the same as that used to treat the opposite side of the fabric. Optionally, a given fabric may be treated with one embodiment of the methods described herein on one side of the fabric and a different embodiment of the methods on the other side to create differing CNT gradients on either side. In FIG. 6a, the reverse side 665 of the fabric has not been treated as indicated by its light grey coloring.

In one embodiment of the large-scale production method, fabric or fabric assemblies with gradient characteristics as described herein are produced on a continuous treatment and assembly line. The material is treated in two stages. The first stage comprises treatment of a top surface of the fabric and the second being treatment of a bottom surface of the fabric. The process comprises the steps of feeding the fabric layer through a conveyor belt system to various stations where the materials are modified according to specified procedures. The procedures comprise chemical and physical manipulations such that a specific gradient in composition and/or properties is achieved in the fabric when examined from the surface of the treated side. The fabric is then passed to a drying/curing area in the same continuous conveyer belt and, when ready, fed through a unit to flip the fabric to expose the as yet unmodified side. The process is then repeated to treat the unmodified side. At the end of this process the fabric of specified gradient properties may be rolled onto a holding roll for storage, sent directly to a cutter for shaping, or combined with similarly processed fabric emerging from a similarly configured unit such that a fabric assembly comprising specified layers is constructed. Alternatively, this assembly may be the final assembly needed for one or more of the above applications.

There are several embodiments of products that may be manufactured from embodiments described herein. One is a single layer composite fabric with gradient properties. This embodiment comprises a single layer of fabric comprising various proportions of fabric, fiber, yarn or tow, carbon nanotubes, metallic, ceramic, or magnetic nano-sized or micro-sized particles, elastomers, and similar materials. The materials are arranged in such a way as to yield a measureable gradient in composition and physical properties as a function of either 1) depth into or thickness of the fabric or 2) distance horizontally across the fabric. The fabric is an overall flexible and contiguous sheet that may be cut, sewn, shaped, adhered, pinned, or otherwise placed over another object for the purpose of protecting the object from projectiles, radiation, electronic signals, chemicals or other substances.

A second product is a projectile resistant fabric assembly that is constructed from several layers of fabric according to the disclosure that may or may not be combined with other materials. The layers of fabric are arranged in order of overall increasing or decreasing measurements of a specified property such as: A) elasticity; B) carbon nanotube content, C) metal or ceramic nano- or micro-particle content, D) fiber density, or E) pressure or temperature of application. The listed parameters are not intended to be exclusive, and other parameters reasonable to those skilled in the art may be substituted. Each layer in the fabric assembly itself may comprise an asymmetric application of one or more of the above parameters. The magnitude of the gradient in the properties of the single fabric layers may be smaller or larger than the gradient of the fabric assembly overall. Furthermore, the fabric layers may comprise several layers of one or more embodiments of the fabric according to the disclosure as well as other types of fabric. Likewise, the direction of the gradient in a single layer of the fabric may be the same or reverse from that of the overall assembly, and there may be a mixture of one or more of the above gradients so as to create a complex, or ‘smart’ fabric assembly. This smart fabric assembly may comprise different types of responsiveness or properties at different depths into the assembly, or at different positions in the horizontal plane of the fabric.

A third product is an anti-projectile gender-specific protective vest. To construct the vest, sections of the fabric, or fabric assemblies as described herein, are cut into panels suited to become the front and back shape of a vest. The selection of materials and their arrangement are tailored or designed such that the assembled vest possesses resistance to penetration of hand gun bullets of a specified type. The vest may be constructed so as to conform to the anatomy of a wearer based on gender.

Similar to the gender-specific vest, anti-projectile body armor for animals could be constructed from the fabrics disclosed herein. The body armor for animals is constructed essentially as described with regard to the gender-specific vest except that the garment is designed to accommodate the anatomy of an animal. This embodiment may be worn by military or police dogs to protect them during hazardous conditions in the field.

A fifth example of a use for the present invention is a projectile and electromagnetic radiation resistant curtain. Specifically, fabric or fabric assemblies as described above are further enhanced with electromagnetic radiation shielding components. The fabric or fabric assemblies are cut, pleated, or otherwise shaped into the shape of a retractable window shade, curtain, drape or window scarf for the purpose of human and electronic equipment protection.

Another product is a snake and small animal bite resistant chap for pant legs. To create these chaps, fabric or fabric assemblies as described in the above examples, is cut and formed into cylindrical tubes or chaps. The cylindrical tubes or chaps are configured so that they may be sewn into the bottom half of pant legs or slid over a pant leg to protect the wearer from skin-penetration injury from snake and small animal bites.

A projectile and electromagnetic radiation resistant pouch/blanket may be constructed from the fabrics disclosed herein. A fabric or fabric assemblies as described herein examples is further enhanced with electromagnetic radiation shielding components and cut so as to construct a pouch or blanket to enclose objects for protection against projectiles and electromagnetic radiation

A projectile resistant backpack and carrying case insert may also be produced using the fabrics of the disclosure. To manufacture this product, fabric or fabric assemblies as described in the herein are cut so as to fit over commercially available backpacks, carrying packs, suitcases, computer cases for protection of the contents against projectiles and electromagnetic radiation.

The fabrics disclosed herein may be used to produce a projectile resistant groin, underarm, collar or helmet insert. Specifically, fabric or fabric assemblies as described in the above examples, are cut so that they may be sewn into groin and underarm area of a suit, jacket, pants or similar garment for the protection against upward moving projectiles. These sections may also be added to a shirt or jacket collar or helmet for targeted protection.

The claims following this written disclosure are hereby expressly incorporated into the present written disclosure, with each claim standing on its own as a separate embodiment. This disclosure includes all permutations of the independent claims with their dependent claims. Moreover, additional embodiments capable of derivation from the independent and dependent claims that follow are also expressly incorporated into the present written description. While the drawings and written description have focused on illustrative anti-projectile/anti-stab fabrics, composites that comprise these fabrics, and methods related to manufacturing the fabrics and composites, it is to be understood that embodiments may be used in any other suitable context. Moreover, it will be understood by those having skill in the art that changes may be made to the details of the above-described embodiments without departing from the underlying principles presented herein. For example, any suitable combination of various embodiments, or the features thereof, is contemplated.

Any methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified.

References to approximations are made throughout this specification, such as by use of the terms “about” or “approximately.” For each such reference, it is to be understood that, in some embodiments, the value, feature, or characteristic may be specified without approximation. For example, where qualifiers such as “about,” are used, these terms include within their scope the qualified words in the absence of their qualifiers. For example, where the term “about 3 mm” is recited with respect to a feature, it is understood that in further embodiments, the feature can have a precisely 3 mm.

Reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment.

We claim:

1. A projectile-resistant fabric comprising:
a first layer of fabric, wherein the first layer of fabric comprises
at least one of fibers, yarns or tow; and
wherein the first layer of fabric has an exterior-facing surface and an interior-facing surface; and
an amount of carbon nanostructures on the exterior-facing surface and an amount of carbon nanostructures on the interior-facing surface, wherein the interstitia of the first layer of fabric is embedded with the carbon nanostructures, and wherein the amount of carbon nanostructures on the exterior-facing surface is greater than the amount of carbon nanostructures on the interior-facing surface.

2. The fabric of claim 1, wherein the first layer of fabric comprises interstitia, wherein the carbon nanostructures are present within the interstitia of the first layer of fabric in a gradient decreasing from the exterior-facing surface of the fabric to the interior-facing surface of the fabric.

3. The fabric of claim 1, wherein the first layer of fabric comprises a blend of molecular types.

4. The fabric of claim 1, wherein the fibers, yarns, or tow comprise at least one type of fiber selected from at least one of:
nylon, polyaramid, polyester, polyurethane, polynitriles, polyethylene, polypropylene, polyvinylchloride, polystyrene, polyacrylonitrile, polytetrafluoroethylene, polymethyl methacrylate, polyvinyl acetate, or natural fibers.

5. The fabric of claim 1, wherein the first layer of fabric has been treated with at least one of n-methyl pyrrolidone or toluene.

6. The fabric of claim 1, wherein the first layer of fabric has been treated with at least one of:
hexane, chloroform, acetone, methyl acetate, ethanol, methanol, demethyl formamide, dimethylsulfoxide, isopropanol, enzymes, or detergent.

7. The fabric of claim 1, wherein the weight of the first layer of fabric is within the range of about 196 g/m² and about 772 g/m².

8. The fabric of claim 7, wherein the weight of the first layer of fabric is within the range of about 240 g/m² and about 280 g/m².

9. The fabric of claim 1, wherein the first layer of fabric has a thickness within a range of about 0.05 mm to about 3 mm.

10. The fabric of claim 9, wherein the first layer of fabric has a thickness within a range of about 0.1 mm to about 2 mm thick.

11. A projectile-resistant composite comprising:
at least two layers of fabric, wherein the at least two layers of fabric comprise
fibers, yarns or tow; and
carbon nanostructures, wherein the interstitia of each of the at least two layers of fabric are embedded with the carbon nanostructures and wherein the carbon nanostructures are present within the interstitia of the at least two layers of fabric in a gradient decreasing from a first surface of each layer of fabric toward a second and opposite-facing surface of each layer of fabric; and
wherein the at least two layers of fabric are heat, pressure, or chemically bonded to either side of a sheet of elastomeric material.

12. The composite of claim 11, wherein the elastomeric material comprises at least one material selected from the group that consists of:
polyisoprene, butadiene, chloroprene, neoprene, styrene-butadiene-blend, nitrile ethylene-propylene blend, epichlorohydrin, polyacrilic silicone, fluorosilicone, fluoroelastomers, polyether block amide, chlorosulfonated polyethylene, ethylene-vinyl acetate, polysulfide, polyacetylene, polyphynylene vinylene, polypyrrole, polythiphene, polyaniline, or polyphenylene sulfide.

13. The composite of claim 11, wherein the weight of each of the at least two layers of fabric is within the range of about 240 g/m² and about 280 g/m².

14. The composite of claim 11, wherein the fibers, yarns, or tow of each of the at least two layers of fabric has a thickness within the range of about 0.05 mm and about 3 mm thick.

15. The composite of claim 14, wherein the fibers, yarns, or tow of each of the at least two layers of fabric has a thickness within the range of about 0.1 mm and about 2 mm thick.

16. A method of manufacturing the projectile-resistant composite of claim 1, comprising the steps of:
embedding carbon nanostructures into one or more layers of fabric,
wherein the one or more layers of fabric comprise fibers, yards or tow;
wherein each of the one or more layers of fabric has a first surface and a second surface;
wherein the carbon nanostructures are embedded into the interstitia between the fibers of each of the one or more layers of fabric by mechanically moving the carbon nanostructures into the one or more layers of fabric through the first surface of each of the one or more layers of fabric; and
wherein the amount of carbon nanostructures on the first surface of each of the one or more layers of fabric is greater than the amount of carbon nanostructures on the second surface of the one or more layers of fabric.

17. The method of claim 16, comprising the step of mechanically moving the carbon nanostructures into the one or more layers of fabric through the first surface of the one or more layers of fabric and into the interstitia between the fibers of the fabric such that the amount of carbon nanostructures are arranged in a gradient decreasing from the first surface of each of the one or more layers of fabric to the second surface of the one or more layers of fabric.

18. The method of claim 16, comprising the step of mechanically softening the fabric by sonication, vibration, rolling, pressing, heating, pounding, or applying negative pressure.

19. The method of claims 16, wherein at least two layers of the fabric are bonded to a first side and a second side of a sheet of elastomeric material using a heat, pressure, or chemical bonding technique.

20. The method of claim 16, wherein the fabric is produced in a continuous fashion on a conveyor belt system and wherein the carbon nanostructure gradient is produced first on one side of the fabric then on the other.
